(19) United States
(12) Patent Application Publication
(10) Pub. No.: US 2026/0158634 A1
(43) Pub. Date: Jun. 11, 2026

(54) POWER TOOL AND OPERATION METHOD OF THE SAME

(71) Applicant: BASSO INDUSTRY CORP., Taichung (TW)

(72) Inventor: Tsung-Han WU, Taichung (TW)

(21) Appl. No.: 19/407,304

(22) Filed: Dec. 3, 2025

(30) Foreign Application Priority Data
Dec. 11, 2024 (TW) 113213655

(51) Int. Cl. B25F 5/00

(52) U.S. Cl. CPC B25F 5/001

(57) ABSTRACT

A power tool includes a motor unit including a motor, a speed detector detecting a rotation speed of the motor, and a controller. The controller calculates a speed difference between a target speed and the rotation speed of the motor, obtains a first limited value based on the speed difference, applies a correction to the first limited value based on a proportional gain to obtain a proportional-control value, applies a correction to the first limited value to obtain an integral-control value, sums up the proportional-control value and the integral-control value to obtain an adjustment output, obtains a second limited value based on the adjustment output, applies a response gain to the second limited value to obtain a speed control output, and outputs a control signal to the motor unit based on the speed control output for the motor to operate at the target speed.

### CROSS-REFERENCE TO RELATED APPLICATION

This application claims priority to Taiwanese Utility Model Patent Application No. 113213655, filed on December 11, 2024, the entire disclosure of which is incorporated by reference herein.

### FIELD

The disclosure relates to a power tool and an operation method of the power tool.

### BACKGROUND

During operation of a conventional power tool, a user may apply different pressing forces to the conventional power tool against a workpiece depending on the personal usage habits of the user or the type of the workpiece the user is currently working on. Since rotation speed of a motor of the conventional power tool decreases to varying degrees in response to the different pressing forces applied, it is difficult to maintain the rotation speed of the motor stably at a desired target speed during operation.

A typical way of maintaining a stable rotation speed is to adjust the duty ratio of a motor control signal according to a difference between an actual rotation speed and the target speed, thereby maintaining stability of the rotation speed of the motor. However, the typical way of maintaining the stable rotation speed still suffers from a relatively high response time, which results in a relatively longer time for the motor of the conventional power tool to reach the target speed.

### SUMMARY

Therefore, an object of the disclosure is to provide a power tool and an operation method of the power tool that can alleviate at least one of the drawbacks of the prior art.

According to an aspect of the disclosure, the power tool includes a motor unit, a speed detector, and a controller. The motor unit is configured to operate based on a control signal and includes a motor. The speed detector is configured to detect a rotation speed of the motor to output a speed signal that indicates the rotation speed thus detected. The controller is electrically connected to the motor unit and the speed detector. The controller is configured to receive the speed signal from the speed detector, calculate a speed difference between a target speed and the rotation speed indicated by the speed signal, obtain a first limited value that is not greater than a first maximum value based on the speed difference thus calculated, apply a first correction to the first limited value based on a proportional gain to obtain a proportional-control value, apply a second correction to the first limited value based on an integral gain to obtain an integral-control value, sum up the proportional-control value and the integral-control value to obtain an adjustment output, obtain a second limited value that is not greater than a second maximum value based on the adjustment output, apply a response gain to the second limited value to obtain a speed control output, and output the control signal based on the speed control output thus obtained to the motor unit for the motor to operate at the target speed.

According to another aspect of the disclosure, the operation method of the power tool mentioned above includes: receiving the speed signal from the speed detector; calculating a speed difference between a target speed and the rotation speed indicated by the speed signal; obtaining a first limited value that is not greater than a first maximum value based on the speed difference thus calculated; applying a first correction to the first limited value based on a proportional gain to obtain a proportional-control value; applying a second correction to the first limited value based on an integral gain to obtain an integral-control value; summing up the proportional-control value and the integral-control value to obtain an adjustment output; obtaining a second limited value that is not greater than a second maximum value based on the adjustment output; applying a response gain to the second limited value to obtain a speed control output; and outputting the control signal based on the speed control output thus obtained to the motor unit for the motor to operate at the target speed.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating a power tool according to an embodiment of the present disclosure.

FIG. 2 is a schematic diagram illustrating a proportional-integral controller according to an embodiment of the present disclosure.

FIG. 3 is a flow chart illustrating an operation method of a power tool according to an embodiment of the present disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

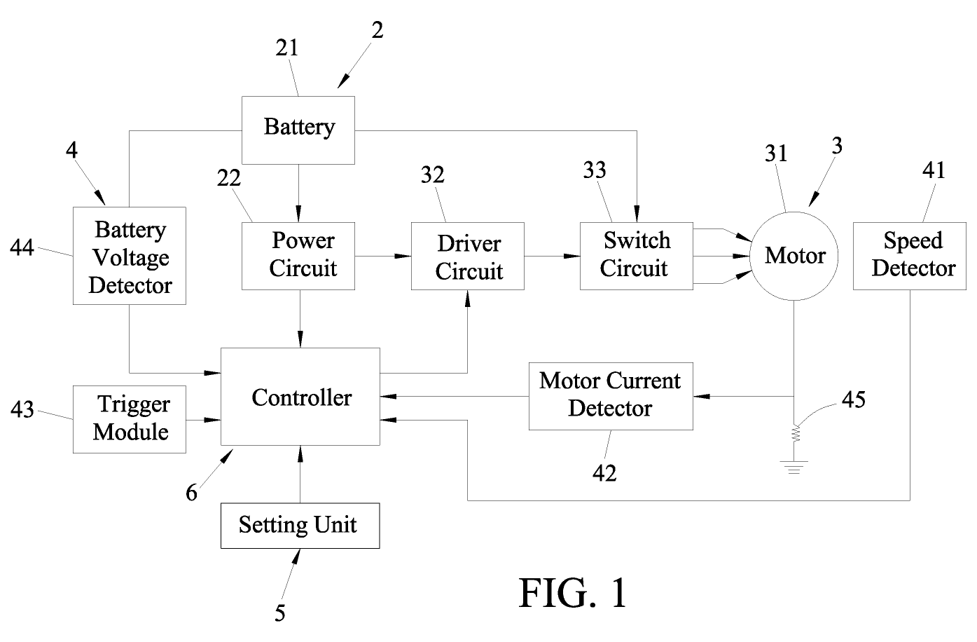

Referring to FIG. 1, a power tool according to an embodiment of the present disclosure includes a power supply unit 2, a motor unit 3, a detection unit 4, a setting unit 5, and a controller 6.

The power supply unit 2 includes a battery 21, and a power circuit 22 electrically connected to the battery 21. The power circuit 22 is configured to stabilize and adjust the voltage of power supplied by the battery 21, and supply the power thus stabilized and adjusted to internal circuits and electronic components of the power tool. In one embodiment, the power circuit 22 may include, for example, a low-dropout (LDO) regulator to supply the power that is stabilized to the power tool, but the disclosure is not limited in this respect.

The motor unit 3 includes a motor 31, a driver circuit 32 electrically connected to the controller 6, and a switch circuit 33 electrically connected to the motor 31 and the driver circuit 32.

In one embodiment, the motor 31 is exemplified as a brushless direct current (BLDC) motor, but the disclosure is not limited in this respect. The driver circuit 32 is configured to receive a control signal in a form of a pulse width modulation (PWM) signal from the controller 6, and control the switch circuit 33 to drive the motor 31 to rotate according to a duty ratio of the PWM signal (i.e., the control signal) thus received. In one embodiment, the switch circuit 33 is implemented using one or more metal-oxide-semiconductor field-effect transistors (MOSFETs), but is not limited to such.

The detection unit 4 includes a speed detector 41, a motor current detector 42, a trigger module 43, a battery voltage detector 44, and a sensing resistor 45.

The speed detector 41 is disposed in correspondence to the motor 31, and is configured to detect a rotation speed of the motor 31 to output a speed signal that indicates the rotation speed thus detected to the controller 6. Specifically, in one embodiment, the speed detector 41 detects a rotor of the motor 31 so as to output to the controller 6 the speed signal that includes relevant information such as a position of the rotor that may represent the rotation speed of the motor 31. In one embodiment, the speed detector 41 is exemplified as, for example, a Hall sensor, but the disclosure is not limited to such. In such an embodiment, the Hall sensor is disposed in proximity to the rotor of the motor 31 so as to detect a variation in magnetic flux generated by the rotor during rotation, which indicates the position of the rotor at a given time.

The motor current detector 42 is configured to cooperate with the sensing resistor 45 to detect an electric current of the motor 31, and output a current signal indicating a current value of the electric current of the motor 31 to the controller 6 for the controller 6 to monitor the electric current of the motor 31. For example, in a case where the current value of the electric current of the motor 31 exceeds a predetermined value that may be set by a user, the controller 6 controls the driver circuit 32 to stop the motor 31 from operating, thereby achieving an over-current protection. In one embodiment, the motor current detector 42 may be exemplified by a differential amplifier circuit that includes an operational amplifier (op-amp) connected across the sensing resistor 45 to measure a voltage drop across the sensing resistor 45, but the disclosure is not limited in this respect.

The trigger module 43 is communicatively connected to the controller 6. The trigger module 43 may include a trigger (not shown) for the user to perform pressing thereon, and a trigger sensor (not shown) configured to detect whether the trigger is being pressed and to output a trigger signal to the controller 6 upon detecting that the trigger is being pressed. In some embodiments, the trigger sensor may be configured to detect a pressed depth to which the trigger is being pressed, and to output the trigger signal based on the pressed depth. Upon receiving the trigger signal, the controller 6 activates the motor unit 3 to start operating the motor 31 based on the trigger signal. In some embodiments, the power tool may further include a safety switch (not shown) that prevents the motor 31 from being activated by accident. In such embodiments, the controller 6 controls the motor unit 3 based on the trigger signal and a state of the safety switch. Since workings of the safety switch in the trigger module 43 is well known in the art and is not the focus of the present disclosure, further descriptions thereof will be omitted for the sake of brevity.

The battery voltage detector 44 is electrically connected to the battery 21 and the controller 6. The battery voltage detector 44 is configured to detect a voltage value of the battery 21, and to output the voltage value thus detected to the controller 6 for the controller 6 to monitor the voltage of the battery 21. In one embodiment, the battery voltage detector 44 may be implemented by an operational amplifier circuit or a battery monitoring integrated circuit, but the disclosure is not limited in this respect.

The setting unit 5 is configured to allow the user to set configurations of the power tool. For example, the user may set a target speed through the setting unit 5. The setting unit 5 is further configured to output the configurations thus set by the user to the controller 6. In one embodiment, the setting unit 5 may be exemplified by a plurality of buttons or a touch panel, but the disclosure is not limited in this respect.

The controller 6 may be exemplified as an integrated circuit that is capable of, for example, analog-to-digital (A/D) conversion, input/output (I/O) detection, PWM signal generation, computational capabilities, etc. In one embodiment, the controller 6 is exemplified as a microcontroller unit (MCU), but the disclosure is not limited thereto. In this embodiment, the controller 6 is communicatively connected to the power supply unit 2, the motor unit 3, the detection unit 4 and the setting unit 5, and is configured to receive the speed signal and the trigger signal, and to generate and output the control signal.

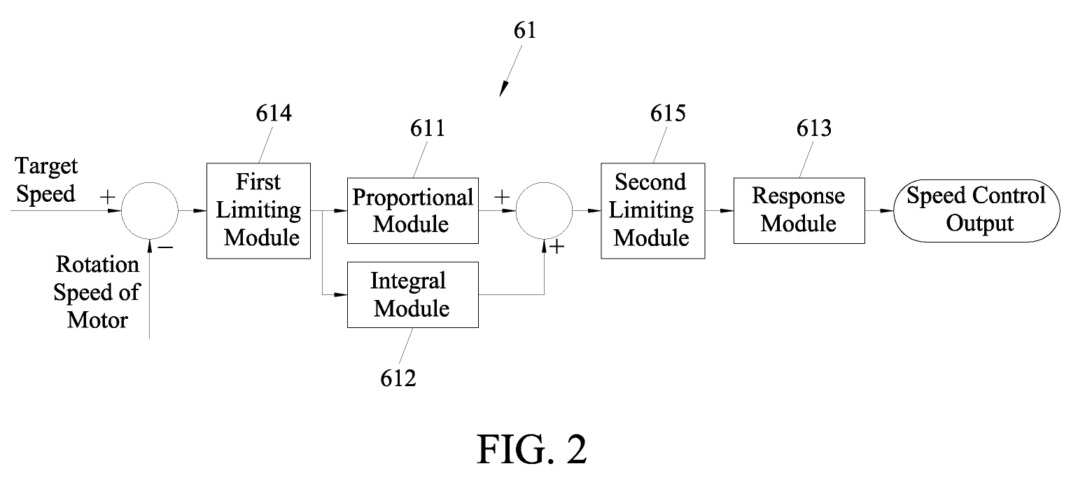

Referring to FIGS. 1 and 2, the controller 6 is further configured to execute a speed regulating procedure. Specifically, the controller 6 includes a proportional-integral (PI) controller 61 for executing the speed regulating procedure. In one embodiment, the PI controller 61 includes a proportional module 611, an integral module 612, a response module 613, a first limiting module 614, and a second limiting module 615. In one embodiment, the PI controller 61 is implemented as a computer program (for example, expressed by MATLAB) which may be read and executed by a processor of the controller 6 to perform the operations as will be described herein. Specifically, the proportional module 611 is configured to perform multiplication of an error signal and a proportional gain (Kp), the integral module 612 is configured to perform summation of the error signal over discrete sampling time points and multiply the result of summation by an integral gain (Ki), and the response module 613 is configured to perform multiplication of an input signal and a response gain (Kg). In the illustrative embodiment of FIG. 2, the proportional module 611 and the integral module 612 are arranged in parallel to each other; that is, the proportional module 611 and the integral module 612 are configured to operate in parallel. The parallel connection of the proportional module 611 and the integral module 612 is arranged in between the first limiting module 614 and the second limiting module 615. The response module 613 is arranged after the second limiting module 615, and is configured to output a speed control output. In this embodiment, the response module 613 is used for applying the response gain (Kg) on an input signal received by the response module 613 to increase a response speed (i.e., reducing a response time) of the power tool. Specifically, the response speed of the power tool corresponds to a time duration in which the power tool is able to achieve the target speed.

The speed regulating procedure that is executed by the PI controller 61 of the controller 6 is described below. In the speed regulating procedure, the controller 6 calculates a speed difference between the target speed and the rotation speed indicated by the speed signal. Then, the first limiting module 614 obtains a first limited value that is not greater than a first maximum value based on the speed difference, and transmits the first limited value to the proportional module 611 and the integral module 612. The proportional module 611, in response to receipt of the first limited value, applies a first correction to the first limited value based on the proportional gain (Kp) to obtain a proportional-control value. The integral module 612, in response to receipt of the first limited value, applies a second correction to the first limited value based on the integral gain (Ki) to obtain an integral-control value. The controller 6 then sums up the proportional-control value and the integral-control value to obtain an adjustment output which is outputted to the second limiting module 615. The second limiting module 615 obtains a second limited value that is not greater than a second maximum value based on the adjustment output, and transmits the second limited value to the response module 613. The response module 613, in response to receipt of the second limited value (serving as the input signal to the response module 613), applies the response gain (Kg) to the second limited value to obtain the speed control output. The controller 6 then outputs the control signal based on the speed control output thus obtained to the motor unit 3 for the motor 31 to operate at the target speed. Specifically, the controller 6 adjusts the duty ratio of the control signal based on the speed control output for the motor 31 to operate at the target speed.

Since a manner of the controller 6 adjusting the duty ratio of the control signal is well known in the art, further description thereof will be omitted for the sake of brevity.

In one embodiment, the controller 6 stores the first maximum value related to the speed difference, and the second maximum value related to the adjustment output. In such an embodiment, the controller 6 obtains the first limited value by the first limiting module 614 comparing the speed difference with the first maximum value, setting the first limited value as the speed difference when the speed difference is not greater than the first maximum value, and setting the first limited value as the first maximum value when the speed difference is greater than the first maximum value. The controller 6 obtains the second limited value by the second limiting module 615 comparing the adjustment output with the second maximum value, setting the second limited value as the adjustment output when the adjustment output is not greater than the second maximum value, and setting the second limited value as the second maximum value when the adjustment output is greater than the second maximum value. In other embodiments, the first limiting module 614 may further compare the speed difference with a first minimum value for the controller 6 to obtain the first limited value that is in a range from the first maximum value to the first minimum value, and the second limiting module 615 may further compare the adjustment output with a second minimum value for the controller 6 to obtain the second limited value that is in a range from the second maximum value to the second minimum value.

In one embodiment, the controller 6 applies the first correction to the first limited value by multiplying the first limited value with the proportional gain (Kp); the controller 6 applies the second correction to the first limited value by performing summation of the first limited value over discrete sampling time points and multiplying the result of summation by the integral gain (Ki). The response module 613 applies the response gain (Kg) to the second limited value by multiplying the second limited value with the response gain (Kg).

In one embodiment, each of the proportional gain (Kp), the integral gain (Ki), and the response gain (Kg) is positively correlated to the target speed. For example, the proportional gain (Kp) may be a number from 0 to 20 (including integers and decimals), the integral gain (Ki) may be an integer number from 0 to 200, and the response gain (Kg) may be a number from 0 to 10 (including integers and decimals).

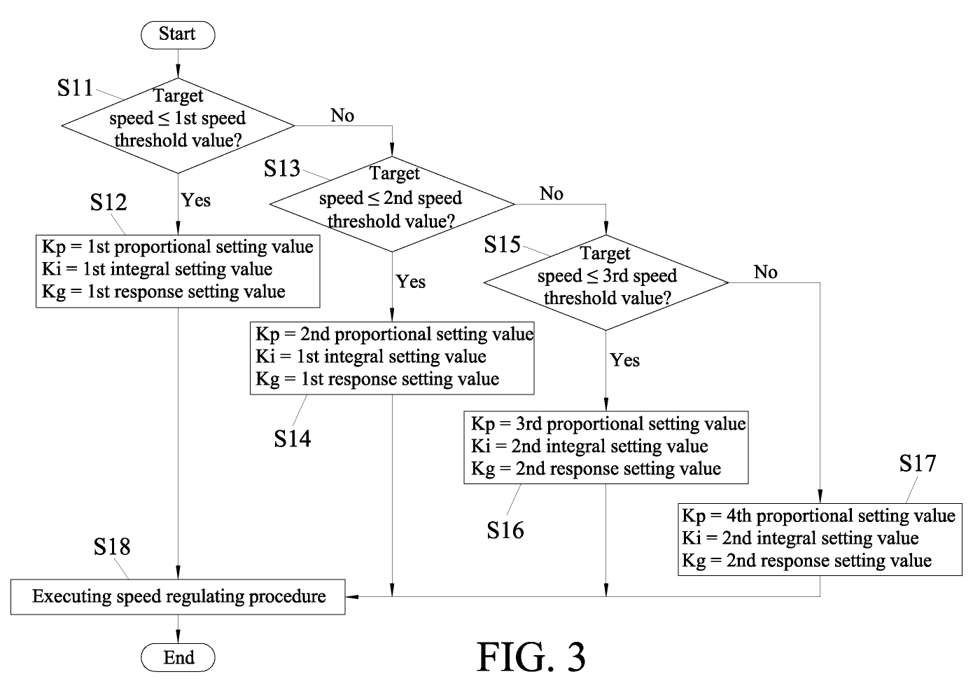

Referring to FIG. 3, an operation method of a power tool according to an embodiment of the present disclosure includes steps S11 to S18. For example, the operation method of FIG. 3 is for the power tool shown in FIGS. 1 and 2. Specifically, steps S11 to S17 are steps in which the controller 6 obtains the proportional gain (Kp), the integral gain (Ki) and the response gain (Kg) based on the target speed prior to the controller 6 executing the speed regulating procedure in step S18. In regards to the proportional gain (Kp), the controller 6 further stores N number of proportional setting values that are different from each other, and (N-1) number of speed threshold values that are different from each other, where N is a positive integer not less than three. The (N-1) number of speed threshold values define N number of speed regions that correspond respectively to N number of speed levels from relatively low speed to relatively high speed. The N number of proportional setting values correspond respectively to the N number of speed regions and are positively correlated to the N number of speed regions. The controller 6 selects one of the N number of speed regions that covers the target speed, and selects as the proportional gain (Kp) one of the N number of proportional setting values that corresponds to said one of the N number of speed regions thus selected.

In regards to the integral gain (Ki), in this embodiment, the controller 6 further stores M number of integral setting values that are different from each other, where M is a positive integer less than N. Each of the M number of integral setting values corresponds to at least one of the N number of speed regions. The M number of integral setting values are positively correlated to the N number of speed regions. The controller 6 selects as the integral gain (Ki) one of the M number of integral setting values that corresponds to said one of the N number of speed regions thus selected.

In regards to the response gain (Kg), in this embodiment, the controller 6 further stores P number of response setting values that are different from each other, where P is a positive integer less than N. Each of the P number of response setting values corresponds to at least one of the N number of speed regions. The P number of response setting values are positively correlated to the N number of speed regions. The controller 6 selects as the response gain (Kg) one of the P number of response setting values that corresponds to said one of the N number of speed regions thus selected.

In the embodiment shown in FIG. 3, N is taken as 4 for example, and both M and P are taken as 2 for example. In other embodiments, N may be 3, 5,6 or any positive integer that is equal to or greater than 3, and M and P may be of different values so long as M and P are less than N. It should be noted that the values respectively of N, M and P may be determined according to specification requirements, and are not limited to the examples of this disclosure. When N =4, the number of speed threshold values is (N-1), which is three; the number of speed regions is N, which is four; the number of speed levels from relatively low speed to relatively high speed is N, which is four; and the number of proportional setting values is N, which is four. For ease of illustration, hereinafter, the three speed threshold values are respectively referred to as “the first speed threshold value,” “the second speed threshold value” and “the third speed threshold value” from low to high, and define four speed regions (i.e., a first speed region not greater than the first speed threshold value, a second speed region greater than the first speed threshold value but not greater than the second speed threshold value, a third speed region greater than the second speed threshold value but not greater than the third speed threshold value, and a fourth speed region greater than the third speed threshold value) that correspond respectively to four speed levels from relatively low speed to relatively high speed; the four proportional setting values are respectively referred to as “the first proportional setting value,” “the second proportional setting value,” “the third proportional setting value” and “the fourth proportional setting value” that correspond respectively to the four speed regions from relatively low speed to relatively high speed, and are, for example, but not limited to, 1, 5, 12 and 20, respectively. The two integral setting values are referred to as “the first integral setting value” and “the second integral setting value” from low to high, and are for example, but not limited to, 80 and 120, respectively. The two response setting values are referred to as “the first response setting value” and “the second response setting value” from low to high, and are for example, but not limited to, 0.2 and 1, respectively. For example, when a predetermined maximum rotation speed of the power tool is 2,500 rpm, the first speed threshold value, the second speed threshold value and the third speed threshold value may respectively be set to 200 rpm, 1000 rpm and 1600 rpm, which may define the first speed region as being not greater than 200 rpm, the second speed region as being greater than 200 but not greater than 1000 rpm, the third speed region as being greater than 1000 but not greater than 1600 rpm, and the fourth speed region as being greater than 1600 but not greater than 2500 rpm; however, the disclosure is not limited in this respect. In this embodiment, the first integral setting value and the first response setting value correspond to the first speed region and the second speed region, and the second integral setting value and the second response setting value correspond to the third speed region and the fourth speed region.

In step S11, the controller 6 determines whether the target speed is not greater than the first speed threshold value (i.e., the controller 6 determines whether the first speed region covers the target speed). When the determination is negative, the flow goes to step S13. Otherwise, the flow goes to step S12.

In step S12, the controller 6 selects the first proportional setting value as the proportional gain (Kp), selects the first integral setting value as the integral gain (Ki), and selects the first response setting value as the response gain (Kg).

In step S13, the controller 6 further determines whether the target speed is not greater than the second speed threshold value (i.e., the controller 6 determines whether the second speed region covers the target speed). When the determination is negative, the flow goes to step S15. Otherwise, the flow goes to step S14.

In step S14, the controller 6 selects the second proportional setting value as the proportional gain (Kp), selects the first integral setting value as the integral gain (Ki), and selects the first response setting value as the response gain (Kg).

In step S15, the controller 6 further determines whether the target speed is not greater than the third speed threshold value (i.e., the controller 6 determines whether the third speed region covers the target speed). When the determination is negative (i.e., the fourth speed region covers the target speed), the flow goes to step S17. Otherwise, the flow goes to step S16.

In step S16, the controller 6 selects the third proportional setting value as the proportional gain (Kp), selects the second integral setting value as the integral gain (Ki), and selects the second response setting value as the response gain (Kg).

In step S17, the controller 6 selects the fourth proportional setting value as the proportional gain (Kp), selects the second integral setting value as the integral gain (Ki), and selects the second response setting value as the response gain (Kg).

In step S18, the controller 6 executes the speed regulating procedure using the proportional gain (Kp), the integral gain (Ki), and the response gain (Kg) thus selected.

Referring to FIGS. 1 to 3, by virtue of the speed detector 41 detecting the rotation speed of the motor 31, and the controller 6 obtaining the proportional-control value and the integral-control value based respectively on the proportional gain (Kp) and the integral gain (Ki), and obtaining the speed control output based on the response gain (Kg), the response speed of the motor unit 3 for the motor 31 to operate in the target speed may be increased. Furthermore, by virtue of the controller 6 obtaining the first limited value that is not greater than the speed difference, and the second limited value that is not greater than the adjustment output, an out of control situation during adjustment of the rotation speed of the motor 31 due to excessively high values generated during computation processes of the controller 6 may be prevented, thereby achieving a relatively stable rotation speed.

By virtue of the abovementioned arrangements, the power tool of this disclosure is able to achieve a relatively stable speed regulation control without experiencing the out of control situation during adjustment. Therefore, the controller 6 may execute the speed regulating procedure via the PI controller 61 as soon as the moment the motor 31 starts operating, thereby achieving stability in operating at the target speed relatively faster as compared to a conventional power tool that needs to wait for the motor of the conventional power tool to operate for a period of time until the rotation speed of the motor is relatively stable within an adjustable range before starting to regulate the rotation speed of the motor.

The controller 6 stores the (N-1) number of speed threshold values, the N number of proportional setting values, the M number of integral setting values, and the P number of response setting values. By virtue of the controller 6 selecting one of the N number of proportional setting values as the proportional gain (Kp), one of the M number of integral setting values as the integral gain (Ki), and one of the P number of response setting values as the response gain (Kg) based on the target speed, relatively better dynamic response, steady-state response and response time may be achieved.

By virtue of a number of the proportional setting values being greater than a number of the integral setting values and a number of the response setting values (i.e., N > M, P), the controller 6 may respond to the target speed with finer resolution. For example, when the target speed is relatively low, the controller 6 may obtain the proportional gain (Kp) that is of relatively lower in value; when the target speed is gradually increased, the controller 6 may obtain the proportional gain (Kp) that is of relatively higher in value. By virtue of the abovementioned arrangement, a relatively better dynamic response can be achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A power tool comprising:
a motor unit configured to operate based on a control signal and including a motor;
a speed detector configured to detect a rotation speed of said motor to output a speed signal that indicates the rotation speed thus detected; and
a controller electrically connected to said motor unit and said speed detector,
wherein said controller is configured to receive the speed signal from said speed detector, calculate a speed difference between a target speed and the rotation speed indicated by the speed signal, obtain a first limited value that is not greater than a first maximum value based on the speed difference thus calculated, apply a first correction to the first limited value based on a proportional gain to obtain a proportional-control value, apply a second correction to the first limited value based on an integral gain to obtain an integral-control value, sum up the proportional-control value and the integral-control value to obtain an adjustment output, obtain a second limited value that is not greater than a second maximum value based on the adjustment output, apply a response gain to the second limited value to obtain a speed control output, and output the control signal based on the speed control output thus obtained to said motor unit for said motor to operate at the target speed.

2. The power tool as claimed in claim 1, wherein the proportional gain is positively correlated to the target speed.

3. The power tool as claimed in claim 1, wherein the integral gain is positively correlated to the target speed.

4. The power tool as claimed in claim 1, wherein the response gain is positively correlated to the target speed.

5. The power tool as claimed in claim 1, wherein said controller stores N number of proportional setting values that are different from each other, and (N-1) number of speed threshold values that are different from each other, where N is a positive integer not less than three; and
wherein the (N-1) number of speed threshold values define N number of speed regions that correspond respectively to N number of speed levels from relatively low speed to relatively high speed, and the N number of proportional setting values correspond respectively to the N number of speed regions and are positively correlated to the N number of speed regions.

6. The power tool as claimed in claim 5, wherein said controller is further configured to select one of the N number of speed regions that covers the target speed, and select as the proportional gain one of the N number of proportional setting values that corresponds to said one of the N number of speed regions thus selected.

7. The power tool as claimed in claim 5, wherein said controller further stores M number of integral setting values that are different from each other, where M is a positive integer less than N; and
wherein each of the M number of integral setting values corresponds to at least one of the N number of speed regions, and the M number of integral setting values are positively correlated to the N number of speed regions.

8. The power tool as claimed in claim 7, wherein said controller is further configured to select one of the N number of speed regions that covers the target speed, and select as the integral gain one of the M number of integral setting values that corresponds to said one of the N number of speed regions thus selected.

9. The power tool as claimed in claim 5, wherein said controller further stores P number of response setting values that are different from each other, where P is a positive integer less than N; and
wherein each of the P number of response setting values corresponds to at least one of the N number of speed regions, and the P number of response setting values are positively correlated to the N number of speed regions.

10. The power tool as claimed in claim 9, wherein said controller is further configured to select one of the N number of speed regions that covers the target speed, and select as the response gain one of the P number of response setting values that corresponds to said one of the N number of speed regions thus selected.

11. The power tool as claimed in claim 1, wherein said controller stores the first maximum value, and said controller is configured to obtain the first limited value by setting the first limited value as the speed difference in response to the speed difference being not greater than the first maximum value, and setting the first limited value as the first maximum value in response to the speed difference being greater than the first maximum value.

12. The power tool as claimed in claim 1, wherein said controller stores the second maximum value, and said controller is configured to obtain the second limited value by setting the second limited value as the adjustment output in response to the adjustment output being not greater than the second maximum value, and setting the second limited value as the second maximum value in response to the adjustment output being greater than the second maximum value.

13. An operation method of the power tool of claim 1, said method being implemented by the controller and comprising:
receiving the speed signal from the speed detector;
calculating a speed difference between a target speed and the rotation speed indicated by the speed signal;
obtaining a first limited value that is not greater than a first maximum value based on the speed difference thus calculated;
applying a first correction to the first limited value based on a proportional gain to obtain a proportional-control value;
applying a second correction to the first limited value based on an integral gain to obtain an integral-control value;
summing up the proportional-control value and the integral-control value to obtain an adjustment output;
obtaining a second limited value that is not greater than a second maximum value based on the adjustment output;
applying a response gain to the second limited value to obtain a speed control output; and
outputting the control signal based on the speed control output thus obtained to the motor unit for the motor to operate at the target speed.

14. The operation method as claimed in claim 13, wherein the proportional gain is positively correlated to the target speed.

15. The operation method as claimed in claim 13, wherein the integral gain is positively correlated to the target speed.

16. The operation method as claimed in claim 13, wherein the response gain is positively correlated to the target speed.

17. The operation method as claimed in claim 13, the controller storing N number of proportional setting values that are different from each other, and (N-1) number of speed threshold values that are different from each other, where N is a positive integer not less than three, the (N-1) number of speed threshold values defining N number of speed regions that correspond respectively to N number of speed levels from relatively low speed to relatively high speed, the N number of proportional setting values corresponding respectively to the N number of speed regions and being positively correlated to the N number of speed regions,
the method further comprising, before applying the first correction to the first limited value, steps of selecting one of the N number of speed regions that covers the target speed, and selecting as the proportional gain one of the N number of proportional setting values that corresponds to said one of the N number of speed regions thus selected.

18. The operation method as claimed in claim 17, the controller further storing M number of integral setting values that are different from each other, where M is a positive integer less than N, each of the M number of integral setting values corresponding to at least one of the N number of speed regions, the M number of integral setting values being positively correlated to the N number of speed regions,
the method further comprising, before applying the second correction to the first limited value, a step of selecting as the integral gain one of the M number of integral setting values that corresponds to said one of the N number of speed regions thus selected.

19. The operation method as claimed in claim 17, the controller further storing P number of response setting values that are different from each other, where P is a positive integer less than N, each of the P number of response setting values corresponding to at least one of the N number of speed regions, the P number of response setting values being positively correlated to the N number of speed regions,
the method further comprising, before applying the response gain to the second limited value, a step of selecting as the response gain one of the P number of response setting values that corresponds to said one of the N number of speed regions thus selected.

20. The operation method as claimed in claim 13, the controller storing the first maximum value and the second maximum value,
wherein the step of obtaining the first limited value includes setting the first limited value as the speed difference in response to the speed difference being not greater than the first maximum value, and setting the first limited value as the first maximum value in response to the speed difference being greater than the first maximum value, and
wherein the step of obtaining the second limited value includes setting the second limited value as the adjustment output in response to the adjustment output being not greater than the second maximum value, and setting the second limited value as the second maximum value in response to the adjustment output being greater than the second maximum value.
